(19) United States
(12) Patent Application Publication
(10) Pub. No.: US 2019/0208836 A1
(43) Pub. Date: Jul. 11, 2019

(54) ELECTRIFIED GARMENT AND METHOD FOR DISTRIBUTING POWER IN AN ELECTRIFIED GARMENT

(71) Applicant: BOMBARDIER RECREATIONAL PRODUCTS INC., Valcourt (CA)

(72) Inventors: Jerome DEMERS, Sherbrooke (CA); Alexandre LECOINTRE, Sherbrooke (CA)

(21) Appl. No.: 16/311,732

(22) PCT Filed: Jun. 22, 2017
(86) PCT No.: PCT/IB2017/053747

§ 371 Date: Dec. 20, 2018

Related U.S. Application Data
(60) Provisional application No. 62/354,005, filed on Jun. 23, 2016.

(51) Int. Cl. A41D 1/00; A41D 13/005; A42B 3/04; H05B 3/34

(52) U.S. Cl. CPC A41D 1/005; A41D 13/0051; H05B 2203/036; H05B 3/342; A41D 2400/12; A42B 3/0406

(57) ABSTRACT

A garment with electrical components is described. The garment comprises a garment body, a power management unit, at least one battery operatively connected to the power management unit, at least one electrical element operatively connected to the power management unit, the electrical element being connected to the at least one battery via the power management unit, and an electrical connection operatively connected to the power management unit for connecting the power management unit to a power supply external to the garment, the power management unit being operable to select between a distribution of power from at least the at least one electrical connection to at least one of the at least one electrical element and the at least one battery, and the at least one battery to the electrical element. A vehicle and garment system and a method for distributing power in a garment are also disclosed.

### CROSS-REFERENCE

The present application claims priority to U.S. Patent Application No. 62/354,005, filed Jun. 23, 2016, entitled “Electrified Garment and Method for Distributing Power in an Electrified Garment,” the entirety of which is incorporated herein.

### TECHNICAL FIELD

The present technology relates to an electrified garment and a method for distributing power in an electrified garment.

### BACKGROUND

Heated garments, having electrically operated heating elements, are sometimes used for keeping a rider warm when riding a vehicle where the rider is exposed to the elements. For example, it may be preferable to wear heated garments when riding a snowmobile, for example, or a motorcycle. A variety of different garments can be provided with heating elements, including jackets, jacket liners, pants, boots, and gloves. Further, some goggles and helmet visors can be provided with heating elements to reduce moisture accumulation on the interior side of the goggles or visors. It is also known to provide garments with plugs for charging mobile telephones and the like. It is also known to provide helmets with radio communication systems.

In some cases, power is supplied to an electrified element or elements, such as heating element(s), of a garment through a battery. The battery is often removable such that it may be plugged into a charging station or the like. For example, US 2014/0263264, published Sep. 18, 2014, and US 2013/0037531, published Feb. 14, 2013, provide heated garments that include heating elements that are powered by battery packs. Use of the heating elements, however, will generally be limited to the battery life.

Alternatively, electrified garments can draw power directly from the vehicle instead of a battery. Typically such a garment will need to be provided with an electrical connection kit to connect to the vehicle's magneto or alternator, as the start-up battery may not be able to supply sufficient wattage to run heating elements, for example. Electrified garments that are electrically connected to a vehicle can be continuously powered as long as the vehicle is in operation. However, when the vehicle is not running or when the rider has dismounted the vehicle and disconnected the garment from the vehicle, power is no longer supplied to the garment.

Similar garments, powered either by batteries or by connecting to the vehicle, may provide connections for other electrical devices in addition (or in place of) the heating elements. For example, U.S. Pat. No. 6,563,424, issued May 13, 2003, and U.S. Pat. No. 8,308,489, issued Nov. 13, 2012, teach electrical garments which are configured to receive electrical devices.

### SUMMARY

It is an object of the present technology to ameliorate at least some of the inconveniences present in the prior art.

One broad aspect of the present technology provides an electrified garment including both a connection to an external power source, such as a vehicle, and a battery pack for stored power. The relative power distribution between the source and the battery are managed by a power management unit to which they are both connected, such that electronic elements may be powered by the vehicle while the garment is connected thereto and powered by the battery when the garment is disconnected therefrom.

One broad aspect of the present technology provides a garment. The garment comprises a garment body; a power management unit connected to the garment body; at least one battery operatively connected to the power management unit; at least one electrical element operatively connected to the power management unit, the at least one electrical element being connected to the at least one battery via the power management unit; and at least one electrical connection operatively connected to the power management unit for connecting the power management unit to a power supply external to the garment, the power management unit being operable to select between a distribution of power from at least the at least one electrical connection to at least one of the at least one electrical element and the at least one battery, and the at least one battery to the at least one electrical element.

In some implementations, the power management unit is adapted to supply power to the at least one electrical element from the at least one battery when the at least one electrical connection is disconnected from the power supply external to the garment.

In some implementations, the garment body is a jacket.

In some implementations, the power management unit is disposed within the garment.

In some implementations, wherein the garment body comprises a battery pocket, the at least one battery being disposed in the battery pocket.

In some implementations, the garment further comprises a control interface operatively connected to the power management unit, the power management unit determining the distribution of power based at least in part on a signal from the control interface.

In some implementations, the control interface provides a plurality of discrete power level settings for the at least one electrical element.

In some implementations, the power supply external to the garment is provided in a vehicle.

In some implementations, the at least one electrical element includes at least one heating element.

In some implementations, the at least one electrical element includes a connector for recharging a battery of an electronic device.

In some implementations, the at least one electrical element includes a connector for supplying power to a helmet electrical element of a helmet.

In some implementations, the at least one electrical element includes a connector for supplying power to a secondary garment.

In some implementations, the at least one electrical element includes a connector for supplying power to at least one of a pair of gloves having at least one gloves electrical element, a pair of pants having at least one pants electrical element, a helmet having at least one helmet electrical element, and a pair of boots having at least one boots electrical element.

In some implementations, the power management unit is configured to determine if power required by the at least one electrical element surpasses power available from the at least one electrical connection alone; and distribute power from both the at least one battery and the at least one electrical connection to the at least one electrical element when power required by the at least one electrical element surpasses power available from the at least one electrical connection alone.

In some implementations, the power management unit is further operable to select a distribution of power from both the at least one electrical connection and the at least one battery.

According to another broad aspect of the present technology, there is provided a method for distributing power in a garment. The method comprises determining, by a power management unit, if power is available from at least one of a battery and an electrical connection, the electrical connection being adapted for providing power from a power supply external to the garment; distributing power, by the power management unit, from the electrical connection to at least one of the battery and at least one electrical element, upon determining that power is available from the electrical connection; and distributing power, by the power management unit, from the battery to the at least one electrical element, upon determining that power is available from the battery and not available from the electrical connection.

In some implementations, distributing power from the electrical connection to the at least one of the battery and at least one electrical element comprises determining, by the power management unit, if the battery has been fully charged; and distributing power, by the power management unit, from the electrical connection only to the at least one electrical element when the battery is fully charged.

In some implementations, distributing power from the electrical connection to the at least one of the battery and at least one electrical element comprises determining, by the power management unit, if power is no longer available from the electrical connection; and distributing power, by the power management unit, from the battery to the at least one electrical element when power is no longer available from the electrical connection.

In some implementations, distributing power from the electrical connection to the at least one of the battery and at least one electrical element comprises determining, by the power management unit, if power required by the at least one electrical element surpasses power available from the electrical connection alone; and distributing power, by the power management unit, from both the battery and the electrical connection to the at least one electrical element when power required by the at least one electrical element surpasses power available from the electrical connection alone.

In some implementations, distributing power from the electrical connection to the at least one of the battery and at least one electrical element comprises determining, by the power management unit, if a charge of the battery has fallen below a threshold; and stopping, by the power management unit, distribution of power from the battery to the at least one electrical element when the charge of the battery has fallen below the threshold.

In some implementations, the method further comprises receiving, by the power management unit, at least one signal from a control interface; and distributing power, by the power management unit, based at least in part on the at least one signal.

In some implementations, the at least one signal indicates a relative percentage of power to be distributed to each of the battery and the at least one electrical element.

According to another broad aspect of the present technology, there is provided a vehicle and garment system comprising a vehicle including a vehicle body, and a propulsion system connected to the vehicle body; and a garment selectively connected to the vehicle, the garment including a garment body; a power management unit connected to the garment body; at least one battery operatively connected to the power management unit; at least one electrical element operatively connected to the power management unit, the at least one electrical element being connected to the at least one battery via the power management unit; and at least one electrical connection operatively connected to the power management unit for connecting the power management unit to a power supply in the vehicle, the power management unit being operable to select between a distribution of power from at least the at least one electrical connection to at least one of the at least one electrical element and the at least one battery, and the at least one battery to the at least one electrical element.

In some implementations, the power management unit is adapted to supply power to the at least one electrical element from the at least one battery when the at least one electrical connection is disconnected from the power supply in the vehicle.

In some implementations, the garment body is a jacket.

In some implementations, the power management unit is disposed within the garment.

In some implementations, the at least one electrical element includes at least one heating element.

In some implementations, the at least one electrical element includes a connector for supplying power to a secondary garment.

In some implementations, the power management unit is configured to determine if power required by the at least one electrical element surpasses power available from the electrical connection alone; and distribute power from both the at least one battery and the at least one electrical connection to the at least one electrical element when power required by the at least one electrical element surpasses power available from the electrical connection alone.

In some implementations, the vehicle is a snowmobile; the vehicle body includes a frame; and the propulsion system includes a motor operatively connected to the frame; and the vehicle further comprises a straddle seat connected to the frame and configured to accommodate at least a driver of the snowmobile; and an endless track operatively connected to the motor.

Additional and/or alternative objects, features, and advantages of the embodiments of the present invention will become apparent from the following description, the accompanying drawings, and the appended claims.

### BRIEF DESCRIPTION OF THE DRAWINGS

For a better understanding of the present invention as well as other objects and further features thereof, reference is made to the following description which is to be used in conjunction with the accompanying drawings, where:

FIG. 1 is a right side elevation view of a snowmobile and a rider wearing an electrified jacket thereupon;

FIG. 2 is a front elevation view of the electrified jacket of FIG. 1, shown in isolation;

FIG. 3 is a schematic diagram of an electrical system of the jacket of FIG. 2;

FIG. 4 is a front elevation view of another implementation of an electrified jacket, heated mittens, heated pants and heated boots;

FIG. 5 is a left side elevation view of another implementation of an electrified jacket and an electrified helmet;

FIG. 6 is a schematic flowchart of a method of controlling power distribution in the electrical system of FIG. 3; and

FIG. 7 is a detailed section of the schematic flowchart of FIG. 6.

### DETAILED DESCRIPTION

Although the present technology is described below with respect to a snowmobile, it is contemplated that aspects could be applied to other vehicles, including, but not limited to: side-by-side vehicles (SSVs), all-terrain vehicles (ATVs), and on-road vehicles such as motorcycles.

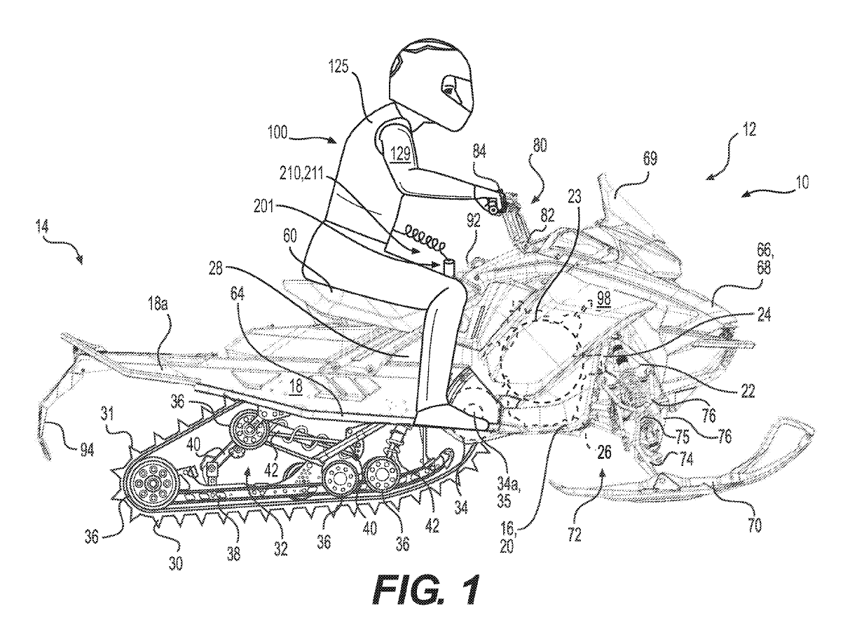

With reference to FIG. 1, a snowmobile 10 includes a front end 12 and a rear end 14 which are defined consistently with a travel direction of the vehicle 10. The snowmobile 10 includes a vehicle body in the form of a frame or chassis 16 which includes a rear tunnel 18, an engine module 20, a front suspension module 22 and an upper structure 24. The tunnel 18 is formed from sheet metal parts assembled to form an inverted U-shape when viewed from the forward or rearward end 12, 14. The inverted U-shaped tunnel 18 has a left side portion 18a and a right side portion 18a (only the right being shown).

A motor 26, schematically illustrated in FIG. 1, is carried in an engine compartment defined by the engine module 20 of the frame 16 and provides, in part, propulsion of the snowmobile 10. In the illustrated implementation, the motor 26 is an internal combustion engine 26, but it is contemplated that it could be, for example, an electric motor or a hybrid. A fuel tank 28, supported above the tunnel 18, supplies fuel to the engine 26 for its operation.

An endless drive track 30 is positioned generally under the tunnel 18, and is operatively connected to the engine 26 via a drivetrain including a belt transmission system (not shown) and a reduction gear assembly 23 (shown schematically). The endless drive track 30 is driven to run about a rear suspension assembly 32 connected to the frame 16 for propulsion of the snowmobile 10. The endless drive track 30 has a plurality of lugs 31 extending from an outer surface thereof to provide traction to the track 30.

The rear suspension assembly 32 includes a pair of drive sprockets 34 (shown schematically) mounted on a drive axle 35 (shown schematically), multiple idler wheels 36 and a pair of slide rails 38 in sliding contact with the endless drive track 30. The drive axle 35 having the drive sprockets 34 mounted thereon defines a drive axle axis 34a. The slide rails 38 are attached to the tunnel 18 by front and rear suspension arms 40 and one or more shock absorbers 42 which include a coil spring surrounding the individual shock absorbers 42. It is contemplated that the snowmobile 10 could be provided with a different implementation of a rear suspension assembly 32 than the one shown herein.

A straddle seat 60 is positioned atop the fuel tank 28. The seat 60 is adapted to accommodate a driver of the snowmobile 10, as shown in FIG. 1. The seat 60 can also be configured to accommodate a passenger.

A fuel tank fill opening covered by a cap 92 is disposed on the upper surface of the fuel tank 28 in front of the seat 60. It is contemplated that the fuel tank fill opening 92 could be disposed elsewhere on the fuel tank 28. A footrest 64 is positioned on each side of the snowmobile 10 below the seat 60 to accommodate the driver's feet. Each of the left and right footrests 64 extends generally laterally outwardly from the corresponding left and right side portion of the tunnel 18. In the illustrated implementation, each side portion 18a of the tunnel 18 is bent laterally outwardly at its bottom edge to form the corresponding footrest 64. It is however contemplated that the footrest 64 could be formed separately from and mounted to the tunnel 18.

At the front end 12 of the snowmobile 10, fairings 66 enclose the engine 26, the continuous variable transmission system 23 and other components of the powerpack such as the air intake system. The fairings 66 include a hood 68 which can be opened to allow access to the engine 26 and other internal components of the snowmobile 10 from the top and the front which may be required, for example, for inspection or maintenance of the engine 26 and/or the powerpack. The fairings 66 also include two side panels 98 extending along the left and right sides of the snowmobile 10. The engine 26 and the transmission system 23 are disposed between the side panels 98. The side panels 98 are both removably connected to the frame 16 and/or to other fairing panels and can be removed to access the internal components from the corresponding lateral side. A windshield 69 connected to the fairings 66 acts as a wind screen to lessen the force of the air on the rider while the snowmobile 10 is moving.

Two skis 70 positioned at the forward end 12 of the snowmobile 10 are attached to the front suspension module 22 of the frame 16 through a front suspension assembly 72. The front suspension module 22 is connected to the front end of the engine module 20. The front suspension assembly 72 includes ski legs 74, shock absorbers 75, supporting arms 76 and ball joints (not shown) for operatively connecting to the respective ski leg 74, supporting arms 76 and a steering column 82.

A steering assembly 80, including the steering column 82 and a handlebar 84, is provided generally forward of the seat 60. The steering column 82 is rotatably connected to the frame 16. The lower end of the steering column 82 is connected to the ski legs 74 via a steering rod (not shown). The handlebar 84 is attached to the upper end of the steering column 82. The handlebar 84 is positioned in front of the seat 60. The handlebar 84 is used to rotate the steering column 82, and thereby the skis 70, in order to steer the vehicle 10. A throttle operator (not shown) in the form of a thumb-actuated throttle lever is mounted to the right side of the handlebar 84. Other types of throttle operators, such as a finger-actuated throttle lever and a twist grip, are also contemplated. A brake actuator (not indicated), in the form of a hand brake lever, is provided on the left side of the handlebar 84 for braking the snowmobile 10 in a known manner. It is contemplated that the windshield 69 could be connected directly to the handlebar 84.

At the rear end of the snowmobile 10, a snow flap 94 extends downward from the rear end of the tunnel 18. The snow flap 94 protects against dirt that can be projected upward from the drive track 30 when the snowmobile 10 is being driven. It is contemplated that the snow flap 94 could be omitted.

The snowmobile 10 includes other components such as a display cluster, an exhaust system, an air intake system, and the like. As it is believed that these components would be readily recognized by one of ordinary skill in the art, further explanation and description of these components will not be provided herein.

An electrified garment 100, generally a wearable item including at least one electronic component, will be described with respect to FIGS. 1 to 3. Specifically the electrified garment 100 is a jacket 100 including a plurality of electric or electronic components, as will be described in detail below. In FIG. 1, the jacket 100 is shown worn by a rider and connected to the snowmobile 10. It is contemplated that the present technology could apply equally to other garments, including but not limited to: pants, gloves, mittens, overalls, boots, one-piece suits, helmets, vests, backpacks and blankets.

The jacket 100 includes a garment body 125, which is the wearable, generally fabric portion of the jacket 100. The garment body 125 includes a main portion 121, two sleeves 129 and a neck portion 127. The garment body 125 is made of a combination of laminated polyester and microfleece for warm, weather-proof performance. It is contemplated that the garment body 125 could be composed of, or incorporate, many other materials, including but not limited to: cotton, leather, nylon, synthetic fiber fabrics, down, wool, silk, and blends or combinations of any of these materials.

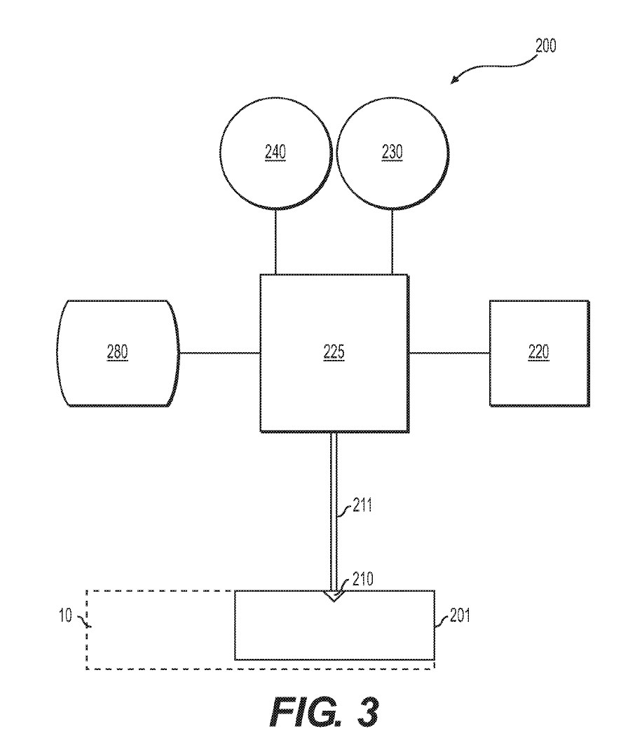

The electrified jacket 100 also includes an electrical system 200 connected to the main portion 121, further illustrated schematically in FIG. 3. In some implementations, some or all of the parts of the electrical system 200 could be situated in one of the portions 121, 127, 129 of the jacket 100, other than the one illustrated.

The electrical system 200 of the jacket 100 includes a power management unit (PMU) 225 for managing the distribution of power across the electrical system 200. All components of the electrical system 200 connect to the PMU 225, such that the PMU 225 can control and manage power flow between the different components according to a method 500, which will be described in more detail below. The PMU 225 is affixed to the garment body 125, but it is contemplated that the PMU 225, or a portion thereof, could be located in the snowmobile 10 and the different components of the electrical system 200 could connect to the PMU 225 through an electrical connection to the snowmobile 10 from the jacket 100. It is also contemplated that the PMU 225, or a portion thereof, could communicate wirelessly, for example, via Bluetooth connection, with electronic components disposed on the vehicle.

The jacket 100 includes an electrical source connection 210 for connecting the electrical system 200 to a snowmobile power source 201, or power supply 201, external to the jacket 100, shown schematically in FIG. 3 and shown operatively connected to the snowmobile 10 in FIG. 1. The source connection 210 extends from the jacket 100 through a connecting cord 211. The cord 211 is illustrated in FIG. 1 as a spiral tether 211.

The power source 201 on the snowmobile 10 selectively connects to the source connection 210 and provides power from a source within the snowmobile 10 which can include, but is not limited to, an alternator, a start-up battery, and a magneto, depending on the implementation of the jacket 100 and the snowmobile 10. While the connection 210 is adapted for connecting to a snowmobile 10 for the jacket 100, it is contemplated that the connection 210 could be made for connecting to other or additional external power sources including, but not limited to: all-terrain vehicles (ATVs), personal water crafts (PWCs), on-road vehicles such as motorcycles and automobiles, and side-by-side vehicles (SSVs).

The jacket 100 includes a battery 220 connected to the PMU 225. The battery 220 can both store power received by the electrical system 200 from the connection 210, and provide stored power to the electrical system 200. In each case, the battery 220 stores or provides power according to a distribution determined by the PMU 225. In some implementations, there could be multiple batteries and/or one or more battery packs connected to the PMU 225 for storing power from and providing power to the jacket 100. The battery 220 is sewn into a battery pocket 222 of the garment body 125. It is contemplated that the battery 220 could be selectively accessible in the battery pocket 222, such that the battery 220 could be removed from the jacket 100.

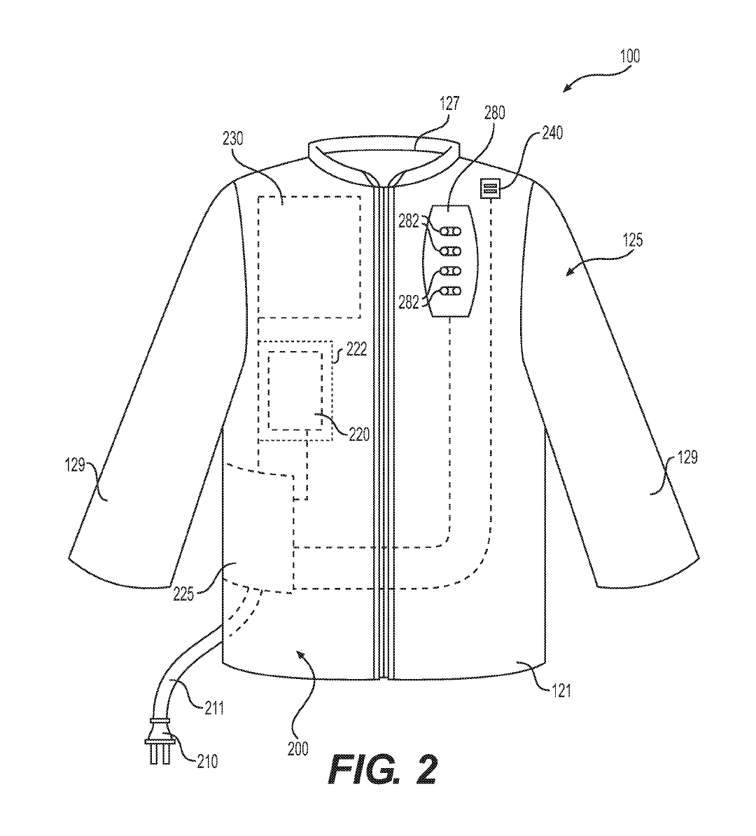

The jacket 100 further includes a heating element 230 for providing heat to the jacket 100, connected to the PMU 225. As illustrated in FIG. 2, the heating element 230 heats the main portion 121 of the jacket 100. It is contemplated that one or more heating elements 230 could be included in all or parts of the arm portions 129 and/or the neck portion 127, either in addition or instead of the main portion 121.

The jacket 100 also includes a USB outlet 240 for charging a cellphone, connected to the PMU 225. In some implementations, the jacket 100 could be provided with multiple USB outlets 240, or with different types of electrical outlets or connections for providing power to electronic devices external to the jacket 100. It is also contemplated that the jacket 100 could be provided without the outlet 240.

The jacket 100 further includes a control interface 280, connected to the PMU 225, for receiving settings from a user of the jacket 100. A portion of the interface 280 extends out through an exterior surface of the jacket 100, where the user of the jacket 100 can select settings for the heating element 230. The user selects the settings using four buttons 282, specifically having three discrete power level setting buttons 282: “low”, “medium” and “high”, as well as an “on/off” button 282. It is contemplated that the interface 280 could be configured with more or less buttons 282. It is also contemplated that the interface 280 could be configured with different mechanisms for turning the heating element 230 on and off or selecting power settings of the heating element 230, including, but not limited to, a touch-screen and a variable setting knob. It is further contemplated that the heating element 230 could have more or less than three settings, including having a continuously variable power level such that the user can smoothly vary the power level of the heating element 230.

In some implementations, the control interface 280 could control other components of the electrical system 200 of the jacket 100. It is also contemplated that the jacket 100 could be provided without the control interface 280 and the PMU 225 could use default settings to control the heating element 230. It is further contemplated that the control interface 280 could be accessed on an interior of the jacket 100. It is also contemplated that the control interface 280 could be disposed elsewhere on the jacket 100, such as one of the sleeve portions 129 of the jacket 100, or on the snowmobile 10 itself. It is also contemplated that the control interface 280 could be implemented on a mobile device, such as a cellphone, in communication with the PMU 225 via a wired connection, such as the USB outlet 240, or via a wireless connection, such as a Bluetooth connection.

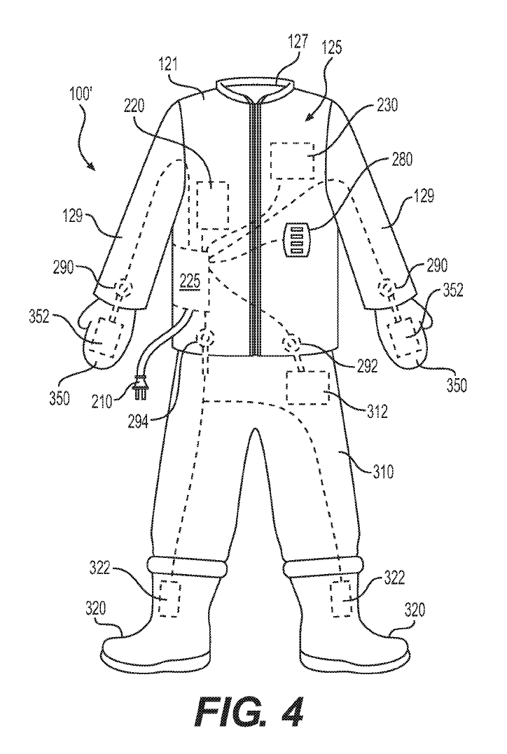

FIG. 4 illustrates another implementation of an electrified garment 100′ according to the present technology, specifically a jacket 100′ adapted for connecting to a plurality of secondary electrified garments. Specifically, the jacket 100′, in addition to the PMU 225, the battery 220, and the electrical source connection 210, is electrically connected to a pair of pants 310, a pair of gloves 350, and a pair of boots 320.

The jacket 100′ includes two gloves connectors 290 for connecting to the gloves 350, one connection 290 being disposed in each sleeve 129 and being connected directly to the PMU 225. The gloves connectors 290 provide power to a heating element 352 of each of the gloves 350.

The jacket 100′ also includes a pants connector 292 for electrically connecting a heating element 312 of the pants 310 to the PMU 225. The connector 292 is disposed on a bottom portion of the main portion 121 of the jacket 100′, but it is contemplated that the connector 292 could be disposed elsewhere on the jacket 100′. For example, in some implementations the pants 310 could be overalls, and the connector 292 could connect to the pants 310 near a shoulder strap of the overalls.

The jacket 100′ further includes a boots connector 294 for providing power, via the PMU 225, to a heating element 322 in each of the boots 320. In some implementations, the boots connector 294 could be two separate boots connectors on the jacket 100′. It is also contemplated that the boots 320 could connect instead to the pants 310, where the heating elements 322 of the boots 320 would receive power via electrical connections in the pants 310, for example at the bottom of each leg of the pants 310. It is contemplated that the jacket 100′ could include more or less connectors for connecting to secondary garments and/or other electrical devices.

As with the jacket 100, the PMU 225 manages power distribution between the source connection 210, the battery 220, and the electrical components connected to the PMU 225 in the jacket 100′, in this case the heating element 230 and the heating elements 312, 322, and 352 of the pants 310, the boots 320, and the gloves 350.

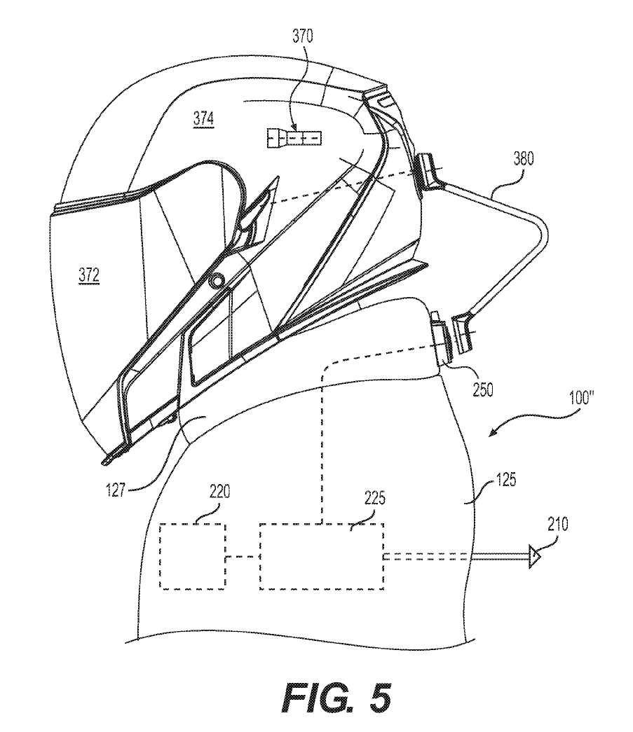

Yet another implementation of an electrified garment 100″ according to the present technology is a jacket 100″ as illustrated in FIG. 5. The jacket 100″ includes a helmet connection 250 connected to the PMU 225, in addition to the PMU 225, the battery 220, and the electrical source connection 210. The helmet connection 250 is disposed in the neck portion 127 of the garment body 125. The helmet connection 250 is adapted to connect to a helmet electrical connector assembly 380 which provides power to an electrified helmet 370.

The electrified helmet 370 includes a visor 372 pivotally connected to a helmet shell 374. The visor 372 includes a heating element (not shown), electrically connected to the helmet electrical connector assembly 380, which uses the power supplied from the jacket 100″ to help prevent accumulation of moisture on the inside of the visor 372. As before, the PMU 225 manages power distribution between the source connection 210, the battery 220, and any electrical components connected to the PMU 225, in this case the helmet connection 250. It is contemplated that the electrified helmet 370 could include a battery 220 and a PMU 225 that is connected directly to the vehicle at connection 210.

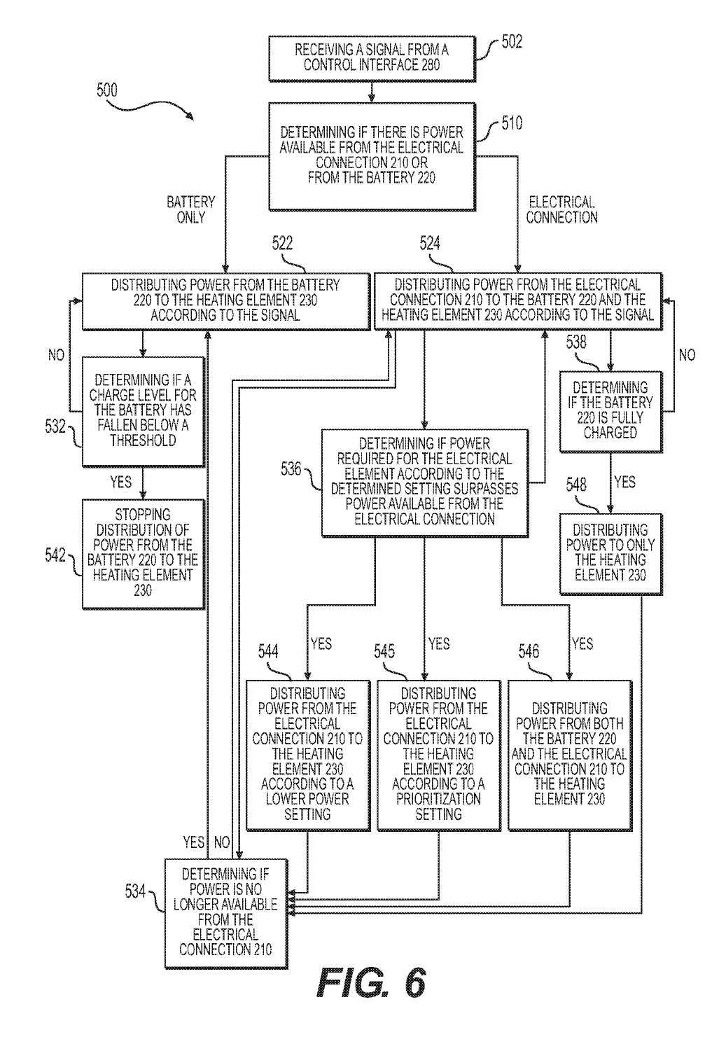

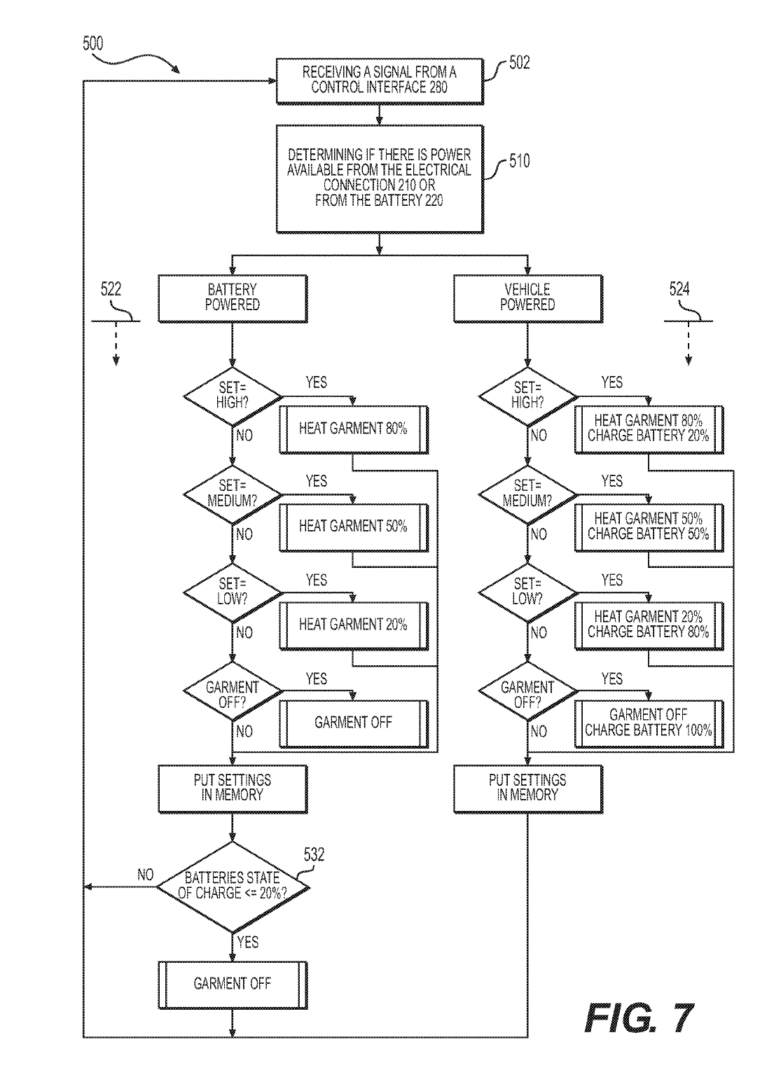

The method 500 by which the power management unit 225 manages the distribution of power to the different components of the jackets 100, 100′, or 100″ is schematically illustrated in the flow-charts of FIGS. 6 and 7. The method 500 will be described as implemented with the heating element 230 of the jacket 100 of FIG. 2, but the method 500 applies equally to jackets 100′, 100″ and generally to any implementation of an electrified garment according to the present technology. It is contemplated that the method 500 could be implemented in hardware or software.

The method 500 generally begins with the PMU 225 receiving at step 502 a signal from the control interface 280, which indicates that the user has used the interface 280 to turn on the heating element 230, as well as the desired power level for the heating element 230. The PMU 225 distributes power based at least in part on the signal, as will be described below, to the heating element 230 of the jacket 100, as well as the battery 220 if power is available from the connection 210.

In some implementations, it is contemplated that the jacket 100 could be provided without the control interface 280. In such a case, the method 500 could begin with the PMU 225 accessing previously stored default settings. It is also contemplated that the electronic elements, such as the heating element 230, may only have settings of “on” and “off”. It is further contemplated that the PMU 225 could provide power to the battery 220 even when the heating element 230 is in the “off” position on the control interface 280.

Next the PMU 225 determines at step 510 if power is available from the battery 220 and the electrical connection 210. In some implementations, the PMU 225 could begin the method 500 at step 510. For example, implementations of the jacket 100 without the control interface 280 will have no setting to detect in step 502 and the PMU 225 will begin the method 500 at step 510.

If the connection 210 is connected to the snowmobile 10, the PMU 225 determines at step 510 that there is power available from the connection 210. The PMU 225 then distributes at step 524 power from the connection 210 to the battery 220 and/or the heating element 230, upon determining at step 510 that power is available from the connection 210. As some power is directed to the battery 220, the battery 220 charges while the jacket 100 is connected to the snowmobile 10.

Available power is distributed at step 524 to the heating element 230 and the battery 220 by the PMU 225 based at least in part on the signal received at step 502, where the signal indicates a relative percentage of power to be distributed. FIG. 7 illustrates the relative percentage of power distributed at step 524 by the PMU 225 according to the signal, where power is split between the battery 220 and the heating element 230 differently depending on the setting indicated by the signal. For a signal indicating a “high” setting, for example, 80% of the available power is sent to the heating element 230, while 20% of available power is sent to the battery 220. For a signal indicating a “low” signal instead, the PMU 225 sends 20% of available power to the heating element 230 and 80% to the battery 220 for charging.

During some implementations of the method 500, following at step 524, the PMU 225 determines at step 538 if the battery 220 is fully charged. When the battery 220 is fully charged, the method 500 then continues by distributing at step 548 the power to the heating element 230 according to the signal as described above at step 524, while no longer sending power to the battery 220. If the battery 220 is not fully charged, the method returns to step 524.

During some implementations of the method 500, the PMU 225 determines 536 if power is required, according to the setting indicated by the signal received 502, by the heating element 230 (and/or other electrical elements) surpasses power available from the electrical connection 210 alone. For example, applying the method 500 to the jacket 100′, signal received 502 may direct the PMU 225 to supply power to all the heating elements 230, 352, 312, 322 at a “high” setting. In response to the PMU 225 detecting this power deficit, at least three options are available to the PMU 225 and will be described. It is contemplated that other actions not enumerated herein may be taken by the PMU 225 in response to the power deficit within the scope of the method 500 as well. If the power required does not surpass power available, the method 500 returns to step 524.

In one possible response to the power deficit for the jacket 100′ in the example above, the method 500 continues from step 536 with the PMU 225 stopping distribution of power to the battery 220 and then distributing 546 power from both the battery 220 and the electrical connection 210 to the heating elements 230, 352, 312, 322 when power required surpasses power available from the connection 210 alone. With the PMU 225 directing power to be distributed from both the battery 220 and the source connection 210, more total power can be supplied to the heating elements 230, 352, 312, 322.

In another possible response to the power deficit from step 536, the PMU 225 distributes at step 545 power to the electrical elements 230, 352, 312, 322 from the source connection 210, but at a setting lower than that entered by the user into the interface 280. For example, while the user may enter the “high” setting for the heating element 230, the PMU 225, upon determining that power available from the source connection 210 and/or the battery 220 is insufficient to enact the “high” setting for the heating element 230 may distribute power according to a “medium” setting to the heating element 230. Depending on particular power distribution settings, either default settings saved to the PMU 225 or according to the signal received at step 502 from the control interface 280, the PMU 225 may or may not provide power from the source connection 210 to charge the battery 220.

It is contemplated that some implementations, for example for the jacket 100′, may provide a prioritization function for power usage of the heating elements 230, 352, 312, 322. For example, the user may prefer to always have the ability to have a “high” setting for the heated boots 322, even if the other elements need to be lowered in power in order to do this. In such a case, the PMU 225 could selectively distribute power from the battery 220 and/or the connection 210 to the heating elements 230, 352, 312, 322 according to the prioritization function.

At any point after distributing 524 power from the electrical connection 210 to the heating element 230 and/or the battery 220, the PMU 225 may determine 534 that power is no longer available from the electrical connection 210. At that point, the method 500 continues with the PMU 225 distributing 522 power to the heating element 230 only from the battery 220. If there is power available from the electrical connection 210, the method 500 returns to step 524.

If instead, at step 510, it is determined that the connection 210 is not connected to the snowmobile 10 but the battery 220 is sufficiently charged, the PMU 225 determines 510 that there is power available from the battery 220. The PMU 225 then distributes 522 power from the battery 220 to the heating element 230, upon determining 510 that power is available from the battery 220 and not available from the electrical connection 210.

For example, this could occur when the user dismounts the snowmobile 10 and disconnects the source connection 210 from the snowmobile 10. When the user is walking around, he or she may continue to receive heat generated by the heating element 230 and is not limited to being attached to the snowmobile 10, or another external power supply, in order to use the heating element 230 or other components of the jacket 100.

Available power from the battery 220 is distributed at step 522 by the PMU 225 to the heating element 230 based on the signal received at step 502, where the signal indicates a relative percentage of power to be distributed. FIG. 7 illustrates the relative percentage of power distributed at step 522 by the PMU 225 according to the signal, where the relative percentage of available power is sent to the heating element 230 differently depending on the setting indicated by the signal. For example, if the user presses the “high” button 282 on the control interface 280, the PMU 225 sends 80% of a maximum power rating of the heating element 230 to the heating element 230. If instead the signal indicates that the user has set the heating element 230 to a “low” setting on the control interface 280, the PMU 225 sends 20% of the power rating to the heating element 230. In cases where multiple electrical elements are set to “on”, such as the cell phone charger 240 as well as the heating element 230, it is contemplated that the relative distributions illustrated in FIG. 7 will be split between the elements 230 and 240.

At any point after distributing at step 522 power from the battery 220 to the heating element 230, the PMU 225 may determine at step 532 if a charge of the battery 220 has fallen below a threshold. If the charge of the battery 220 has not fallen below the threshold, the method 500 then returns to step 522. If it is determined that the charge of the battery 220 has fallen below the threshold, the method 500 then continues with the PMU 225 stopping 542 distribution of power from the battery 220 to the heating element 230. The threshold is set by the PMU 225 to protect the battery 220 from damage caused excessive discharge. However, in some implementations, the interface 280 could provide controls for adjusting the threshold at which the PMU 225 would turn off the heating element 230 of the jacket 100. It is also contemplated that the PMU 225 could initiate a visual or audio signal to alert the user that the charge of the battery 220 has fallen below the threshold. It is also contemplated that the jacket 100 could provide a visual display of the charge of the battery 220. It is further contemplated that steps could be implemented when using only power from the battery 220 similar to steps 544 and 545 of adjusting power levels distributed to the heating element 230 according to a lower or prioritized setting.

It is contemplated that the method 500 could include additional or different steps, either to perform additional functions and/or to perform the steps described above. In some systems, for example, the method 500 automatically saves settings entered by the user to a memory of the PMU 225, as is illustrated in FIG. 7. This is not a limiting step, but it may be included in certain implementations.

The garment 100 and the method 500 implemented in accordance with some non-limiting implementations of the present technology can be represented as presented in the following numbered clauses.

CLAUSE 1: A garment (100, 100′, 100″), comprising: a garment body (125); a power management unit (225) connected to the garment body (125); at least one battery (220) operatively connected to the power management unit (225); at least one electrical element (230, 240, 250, 290, 292, 352, 312, 322) operatively connected to the power management unit (225), the at least one electrical element (230, 240, 250, 290, 292, 294, 352, 312, 322) being connected to the at least one battery (220) via the power management unit (225); and at least one electrical connection (210) operatively connected to the power management unit (225) for connecting the power management unit (225) to a power supply (201) external to the garment (100, 100′, 100″), the power management unit (225) being operable to select between a distribution of power from at least: the at least one electrical connection (210) to at least one of the at least one electrical element (230, 240, 250, 290, 292, 352, 312, 322) and the at least one battery (220), and the at least one battery (220) to the at least one electrical element (230, 240, 250, 290, 292, 294, 352, 312, 322).

CLAUSE 2: The garment (100, 100′, 100″) of clause 1, wherein the power management unit (225) is adapted to supply power to the at least one electrical element (230, 240, 250, 290, 292, 294, 352, 312, 322) from the at least one battery (220) when the at least one electrical connection (210) is disconnected from the power supply (201) external to the garment (100, 100′, 100″).

CLAUSE 3: The garment (100, 100′, 100″) of clause 1 or 2, wherein the garment body (125) is a jacket (125).

CLAUSE 4: The garment (100, 100′, 100″) of any one of clauses 1 to 3, wherein the power management unit (225) is disposed within the garment (100, 100′, 100″).

CLAUSE 5: The garment (100, 100′, 100″) of any one of clauses 1 to 4, wherein the garment body (125) comprises a battery pocket (222), the at least one battery (220) being disposed in the battery pocket (222).

CLAUSE 6: The garment (100, 100′, 100″) of any one of clauses 1 to 5, further comprising a control interface (280) operatively connected to the power management unit (225), the power management unit (225) determining the distribution of power based at least in part on a signal from the control interface (280).

CLAUSE 7: The garment (100, 100′, 100″) of clause 6, wherein the control interface (280) provides a plurality of discrete power level settings for the at least one electrical element (230, 240, 250, 290, 292, 294, 352, 312, 322).

CLAUSE 8: The garment (100, 100′, 100″) of any one of clauses 1 to 7, wherein the power supply (201) external to the garment (100, 100′, 100″) is provided in a vehicle (10).

CLAUSE 9: The garment (100, 100′, 100″) of any one of clauses 1 to 8, wherein the at least one electrical element (230, 240, 250, 290, 292, 294, 352, 312, 322) includes at least one heating element (230, 352, 312, 322).

CLAUSE 10: The garment (100, 100′, 100″) of any one of clauses 1 to 9, wherein the at least one electrical element (230, 240, 250, 290, 292, 294, 352, 312, 322) includes a connector (240) for recharging a battery (220) of an electronic device.

CLAUSE 11: The garment (100, 100′, 100″) of any one of clauses 1 to 10, wherein the at least one electrical element (230, 240, 250, 290, 292, 294, 352, 312, 322) includes a connector (250) for supplying power to a helmet electrical element of a helmet (370).

CLAUSE 12: The garment (100, 100′, 100″) of any one of clauses 1 to 11, wherein the at least one electrical element (230, 240, 250, 290, 292, 294, 352, 312, 322) includes a connector (290, 292, 294) for supplying power to a secondary garment (310, 320, 350).

CLAUSE 13: The garment (100, 100′, 100″) of any one of clauses 1 to 12, wherein the at least one electrical element (230, 240, 250, 290, 292, 294, 352, 312, 322) includes a connector (290, 292, 294, 250) for supplying power to at least one of: a pair of gloves (350) having at least one gloves electrical element (352), a pair of pants (310) having at least one pants electrical element (312), a helmet (370) having at least one helmet electrical element, and a pair of boots (320) having at least one boots electrical element (322).

CLAUSE 14: The garment (100, 100′, 100″) of any one of clauses 1 to 13, wherein the power management unit (225) is configured to: determine if power required by the at least one electrical element (230, 240, 250, 290, 292, 294, 352, 312, 322) surpasses power available from the at least one electrical connection (210) alone; and distribute power from both the at least one battery (220) and the at least one electrical connection (210) to the at least one electrical element (230, 240, 250, 290, 292, 294, 352, 312, 322) when power required by the at least one electrical element (230, 240, 250, 290, 292, 294, 352, 312, 322) surpasses power available from the at least one electrical connection (210) alone.

CLAUSE 15: The garment (100, 100′, 100″) of any one of clauses 1 to 14, wherein the power management unit (225) is further operable to select a distribution of power from both the at least one electrical connection (210) and the at least one battery (220).

CLAUSE 16: A method for distributing power in a garment (100, 100′, 100″), the method comprising: determining, by a power management unit (225), if power is available from at least one of a battery (220) and an electrical connection (210), the electrical connection (210) being adapted for providing power from a power supply (201) external to the garment (100, 100′, 100″); distributing power, by the power management unit (225), from the electrical connection (210) to at least one of the battery (220) and at least one electrical element (230, 240, 250, 290, 292, 294, 352, 312, 322), upon determining that power is available from the electrical connection (210); and distributing power, by the power management unit (225), from the battery (220) to the at least one electrical element (230, 240, 250, 290, 292, 294, 352, 312, 322), upon determining that power is available from the battery (220) and not available from the electrical connection (210).

CLAUSE 17. The method of clause 16, wherein distributing power from the electrical connection (210) to the at least one of the battery (220) and at least one electrical element (230, 240, 250, 290, 292, 294, 352, 312, 322) comprises: determining, by the power management unit (225), if the battery (220) has been fully charged; and distributing power, by the power management unit (225), from the electrical connection (210) only to the at least one electrical element (230, 240, 250, 290, 292, 294, 352, 312, 322) when the battery (220) is fully charged.

CLAUSE 18: The method of clause 16 or 17, wherein distributing power from the electrical connection (210) to the at least one of the battery (220) and at least one electrical element (230, 240, 250, 290, 292, 294, 352, 312, 322) comprises: determining, by the power management unit (225), if power is no longer available from the electrical connection (210); and distributing power, by the power management unit (225), from the battery (220) to the at least one electrical element (230, 240, 250, 290, 292, 294, 352, 312, 322) when power is no longer available from the electrical connection (210).

CLAUSE 19: The method of any one of clauses 16 to 18, wherein distributing power from the electrical connection (210) to the at least one of the battery (220) and at least one electrical element (230, 240, 250, 290, 292, 294, 352, 312, 322) comprises: determining, by the power management unit (225), if power required by the at least one electrical element (230, 240, 250, 290, 292, 294, 352, 312, 322) surpasses power available from the electrical connection (210) alone; and distributing power, by the power management unit (225), from both the battery (220) and the electrical connection (210) to the at least one electrical element (230, 240, 250, 290, 292, 294, 352, 312, 322) when power required by the at least one electrical element (230, 240, 250, 290, 292, 294, 352, 312, 322) surpasses power available from the electrical connection (210) alone.

CLAUSE 20: The method of any one of clauses 16 to 19, wherein distributing power from the electrical connection (210) to the at least one of the battery (220) and at least one electrical element (230, 240, 250, 290, 292, 294, 352, 312, 322) comprises: determining, by the power management unit (225), if a charge of the battery (220) has fallen below a threshold; and stopping, by the power management unit (225), distribution of power from the battery (220) to the at least one electrical element (230, 240, 250, 290, 292, 294, 352, 312, 322) when the charge of the battery (220) has fallen below the threshold.

CLAUSE 21. The method of any one of clauses 16 to 20, further comprising: receiving, by the power management unit (225), at least one signal from a control interface (280); and distributing power, by the power management unit (225), based at least in part on the at least one signal.

CLAUSE 22. The method of clause 21, wherein the at least one signal indicates a relative percentage of power to be distributed to each of the battery (220) and the at least one electrical element (230, 240, 250, 290, 292, 294, 352, 312, 322).

CLAUSE 23. A vehicle (10) and garment (100, 100′, 100″) system comprising: a vehicle (10) including: a vehicle body (16), and a propulsion system (20) connected to the vehicle body (16); and a garment (100, 100′, 100″) selectively connected to the vehicle (10), the garment (100, 100′, 100″) including: a garment body (125); a power management unit (225) connected to the garment body (125); at least one battery (220) operatively connected to the power management unit (225); at least one electrical element (230, 240, 250, 290, 292, 294, 352, 312, 322) operatively connected to the power management unit (225), the at least one electrical element (230, 240, 250, 290, 292, 294, 352, 312, 322) being connected to the at least one battery (220) via the power management unit (225); and at least one electrical connection (210) operatively connected to the power management unit (225) for connecting the power management unit (225) to a power supply (201) in the vehicle (10), the power management unit (225) being operable to select between a distribution of power from at least: the at least one electrical connection (210) to at least one of the at least one electrical element (230, 240, 250, 290, 292, 294, 352, 312, 322) and the at least one battery (220), and the at least one battery (220) to the at least one electrical element (230, 240, 250, 290, 292, 294, 352, 312, 322).

CLAUSE 24. The system of clause 23, wherein the power management unit (225) is adapted to supply power to the at least one electrical element (230, 240, 250, 290, 292, 294, 352, 312, 322) from the at least one battery (220) when the at least one electrical connection (210) is disconnected from the power supply (201) in the vehicle (10).

CLAUSE 25. The system of clause 23 or 24, wherein the garment body (125) is a jacket (125).

CLAUSE 26. The system of any one of clauses 23 to 25, wherein the power management unit (225) is disposed within the garment (100, 100′, 100″).

CLAUSE 27. The system of any one of clauses 23 to 26, wherein the at least one electrical element (230, 240, 250, 290, 292, 294, 352, 312, 322) includes at least one heating element (230, 352, 312, 322).

CLAUSE 28. The system of any one of clauses 23 to 27, wherein the at least one electrical element (230, 240, 250, 290, 292, 294, 352, 312, 322) includes a connector (290, 292, 294) for supplying power to a secondary garment (310, 320, 350).

CLAUSE 29. The system of any one of clauses 23 to 28, wherein the power management unit (225) is configured to: determine if power required by the at least one electrical element (230, 240, 250, 290, 292, 294, 352, 312, 322) surpasses power available from the electrical connection (210) alone; and distribute power from both the at least one battery (220) and the at least one electrical connection (210) to the at least one electrical element (230, 240, 250, 290, 292, 294, 352, 312, 322) when power required by the at least one electrical element (230, 240, 250, 290, 292, 294, 352, 312, 322) surpasses power available from the electrical connection (210) alone.

CLAUSE 30. The system of any one of clauses 23 to 29, wherein: the vehicle (10) is a snowmobile (10); the vehicle body (16) includes a frame (16); and the propulsion system (20) includes a motor (20) operatively connected to the frame (16); and the vehicle (10) further comprises: a straddle seat (60) connected to the frame (16) and configured to accommodate at least a driver of the snowmobile (10); and an endless track (30) operatively connected to the motor (20).

Modifications and improvements to the above-described implementations of the present technology may become apparent to those skilled in the art. The foregoing description is intended to be exemplary rather than limiting. The scope of the present technology is therefore intended to be limited solely by the scope of the appended claims.

1. A garment, comprising:
a garment body;
a power management unit connected to the garment body;
at least one battery operatively connected to the power management unit;
at least one electrical element operatively connected to the power management unit, the at least one electrical element being connected to the at least one battery via the power management unit; and
at least one electrical connection operatively connected to the power management unit for connecting the power management unit to a power supply external to the garment,
the power management unit being operable to select between a distribution of power from at least:
the at least one electrical connection to at least one of the at least one electrical element and the at least one battery, and
the at least one battery to the at least one electrical element.

2. The garment of claim 1, wherein the power management unit is adapted to supply power to the at least one electrical element from the at least one battery when the at least one electrical connection is disconnected from the power supply external to the garment.

3. (canceled)

4. The garment of claim 1, wherein the power management unit is disposed within the garment.

5. (canceled)

6. The garment of claim 1, further comprising a control interface operatively connected to the power management unit, the power management unit determining the distribution of power based at least in part on a signal from the control interface.

7. (canceled)

8. The garment of claim 1, wherein the power supply external to the garment is provided in a vehicle.

9. The garment of claim 1, wherein the at least one electrical element includes at least one heating element.

10. The garment of claim 1, wherein the at least one electrical element includes a connector for at least one of recharging a battery of an electronic device, supplying power to a helmet electrical element of a helmet, and supplying power to a secondary garment.

11.-13. (canceled)

14. The garment of claim 1, wherein the power management unit is configured to:
determine if power required by the at least one electrical element surpasses power available from the at least one electrical connection alone; and
distribute power from both the at least one battery and the at least one electrical connection to the at least one electrical element when power required by the at least one electrical element surpasses power available from the at least one electrical connection alone.

15. The garment of claim 1, wherein the power management unit is further operable to select a distribution of power from both the at least one electrical connection and the at least one battery.

16. A method for distributing power in a garment, the method comprising:
determining, by a power management unit, if power is available from at least one of a battery and an electrical connection, the electrical connection being adapted for providing power from a power supply external to the garment;
distributing power, by the power management unit, from the electrical connection to at least one of the battery and at least one electrical element, upon determining that power is available from the electrical connection; and
distributing power, by the power management unit, from the battery to the at least one electrical element, upon determining that power is available from the battery and not available from the electrical connection.

17. The method of claim 16, wherein distributing power from the electrical connection to the at least one of the battery and at least one electrical element comprises:
determining, by the power management unit, if the battery has been fully charged; and
distributing power, by the power management unit, from the electrical connection only to the at least one electrical element when the battery is fully charged.

18. The method of claim 16, wherein distributing power from the electrical connection to the at least one of the battery and at least one electrical element comprises:
determining, by the power management unit, if power is no longer available from the electrical connection; and
distributing power, by the power management unit, from the battery to the at least one electrical element when power is no longer available from the electrical connection.

19. The method of claim 16, wherein distributing power from the electrical connection to the at least one of the battery and at least one electrical element comprises:
determining, by the power management unit, if power required by the at least one electrical element surpasses power available from the electrical connection alone; and
distributing power, by the power management unit, from both the battery and the electrical connection to the at least one electrical element when power required by the at least one electrical element surpasses power available from the electrical connection alone.

20. The method of claim 16, wherein distributing power from the electrical connection to the at least one of the battery and at least one electrical element comprises:
determining, by the power management unit, if a charge of the battery has fallen below a threshold; and
stopping, by the power management unit, distribution of power from the battery to the at least one electrical element when the charge of the battery has fallen below the threshold.

21.-22. (canceled)

23. A vehicle and garment system comprising:
a vehicle including:
a vehicle body, and
a propulsion system connected to the vehicle body; and
a garment selectively connected to the vehicle, the garment including:
a garment body;
a power management unit connected to the garment body;
at least one battery operatively connected to the power management unit;
at least one electrical element operatively connected to the power management unit, the at least one electrical element being connected to the at least one battery via the power management unit; and
at least one electrical connection operatively connected to the power management unit for connecting the power management unit to a power supply in the vehicle,
the power management unit being operable to select between a distribution of power from at least:
the at least one electrical connection to at least one of the at least one electrical element and the at least one battery, and
the at least one battery to the at least one electrical element.

24. The system of claim 23, wherein the power management unit is adapted to supply power to the at least one electrical element from the at least one battery when the at least one electrical connection is disconnected from the power supply in the vehicle.

25.-28. (canceled)

29. The system of claim 23, wherein the power management unit is configured to:
determine if power required by the at least one electrical element surpasses power available from the electrical connection alone; and
distribute power from both the at least one battery and the at least one electrical connection to the at least one electrical element when power required by the at least one electrical element surpasses power available from the electrical connection alone.

30. (canceled)

31. The garment of claim 1, wherein the power management unit is operable to manage power flow:
from the at least one electrical connection to the at least one battery;
from the at least one electrical connection to the at least one electrical element;
from the at least one battery to the at least one electrical element; and
from the at least one electrical connection to both the at least one battery and the at least one electrical element.

32. The method of claim 16, wherein distributing power, by the power management unit, from the electrical connection comprises selectively distributing power, by the power management unit, from the electrical connection to one of:
the at least one battery;
the at least one electrical element; and
both the at least one battery and the at least one electrical element.

33. The system of claim 23, wherein the power management unit is operable to manage power flow:
from the at least one electrical connection to the at least one battery;
from the at least one electrical connection to the at least one electrical element;
from the at least one battery to the at least one electrical element; and
from the at least one electrical connection to both the at least one battery and the at least one electrical element.
